(19) United States
(12) Patent Application Publication
(10) Pub. No.: US 2025/0201911 A1
(43) Pub. Date: Jun. 19, 2025

(54) ALL SOLID-STATE BATTERY AND METHOD OF PREPARING SAME

(71) Applicant: SAMSUNG SDI CO., LTD., Yongin-si (KR)

(72) Inventors: Kyulin LEE, Yongin-si (KR); Jayhyok SONG, Yongin-si (KR); Jungmin HAN, Yongin-si (KR); Jinkyu KIM, Yongin-si (KR)

(21) Appl. No.: 18/935,801

(22) Filed: Nov. 4, 2024

(30) Foreign Application Priority Data
Dec. 14, 2023 (KR) 10-2023-0182272

(51) Int. Cl. H01M 10/0562; H01M 4/136; H01M 4/1397; H01M 4/66

(52) U.S. Cl. CPC H01M 10/0562; H01M 4/136; H01M 4/1397; H01M 4/667

(57) ABSTRACT

An all solid-state battery includes a negative electrode; a positive electrode; and a solid electrolyte layer between the negative electrode and the positive electrode, wherein the solid electrolyte layer includes a first solid electrolyte layer in contact with the negative electrode, and a second solid electrolyte layer in contact with the positive electrode, the first solid electrolyte layer is an irregular layer and includes an alcohol.

### CROSS-REFERENCE TO RELATED APPLICATION

This application claims priority to and the benefit of Korean Patent Application No. 10-2023-0182272 filed in the Korean Intellectual Property Office on Dec. 14, 2023, the entire contents of which are incorporated herein by reference.

### BACKGROUND

### 1. Field

Embodiments relate to an all solid-stated battery and a method of preparing the same.

### 2. Description of the Related Art

Recently, there has been a rapid progress in electric devices using batteries, e.g., mobile phones, laptop computers, or electric vehicles.

As such a battery, the development for an all solid-state battery using lithium metal as a negative electrode, has been considered. An all solid-state battery refers to a battery in which all materials are solid, e.g., a battery using a solid electrolyte. The all solid-state battery may be structurally strong because an electrolyte is solid, and thus, there may be a low risk of fire or explosion caused by the electrolyte leakage due to external impact, or the like. The all solid-state battery may be formed in various shapes.

### SUMMARY

The embodiments may be realized by providing an all solid-state battery including a negative electrode; a positive electrode; and a solid electrolyte layer between the negative electrode and the positive electrode, wherein the solid electrolyte layer includes a first solid electrolyte layer in contact with the negative electrode, and a second solid electrolyte layer in contact with the positive electrode, the first solid electrolyte layer is an irregular layer and includes an alcohol.

The first solid electrolyte layer may be a dense layer.

The first solid electrolyte layer may include the alcohol in an amount of about 0.08 wt % to about 0.13 wt %, based on a total weight of the first solid electrolyte layer.

The first solid electrolyte layer may include a first solid electrolyte, and the first solid electrolyte may include a sulfide solid electrolyte.

The second solid electrolyte layer may include a second solid electrolyte, and the second solid electrolyte may include a sulfide solid electrolyte, an oxide solid electrolyte, a halide solid electrolyte, or a solid polymer electrolyte.

The negative electrode may include a negative electrode current collector and a negative electrode coating layer on the negative electrode current collector, and the negative electrode coating layer may include a metal, a carbon material, and a binder.

The carbon material may include amorphous carbon, crystalline carbon, or a mixture thereof.

The metal may include Ag, Au, Sn, Zn, Al, Mg, Ge, Cu, In, Ni, Bi, Pt, Pd, or a combination thereof.

The alcohol may include ethanol, propanol, isopropanol, butanol, t-butanol, or a combination thereof.

The first solid electrolyte layer may have a thickness of about 10 μm to about 200 μm.

The second solid electrolyte layer may have a thickness of about 10 μm to about 200 μm.

The second solid electrolyte layer may include a large-particle solid electrolyte having a particle diameter of more than about 0.1 μm.

The large-particle solid electrolyte may have a particle diameter of about 0.5 μm to about 20 μm.

The embodiments may be realized by providing a method of preparing an all solid-state battery, the method including coating a first solid electrolyte layer composition having a viscosity of about 5 cPs to about 1,000 cPs at 25° C. on a negative electrode and drying to prepare a first solid electrolyte layer; positioning a second solid electrolyte layer and a positive electrode on the first solid electrolyte layer to prepare a laminate, and pressurizing the laminate.

The first solid electrolyte layer composition may include a first solid electrolyte and an alcohol.

The alcohol may include ethanol, propanol, isopropanol, butanol, t-butanol, or a combination thereof.

The first solid electrolyte layer composition may include a first solid electrolyte in an amount of about 1 wt % to about 20 wt %, based a total weight of the first solid electrolyte layer composition.

### BRIEF DESCRIPTION OF THE DRAWINGS

Features will be apparent to those of skill in the art by describing in detail exemplary embodiments with reference to the attached drawings in which:

FIG. 1 is a schematic diagram showing the all solid-state battery according to one or more embodiments.

FIG. 2 is a schematic diagram showing the all solid-state battery according to another embodiment.

FIG. 3 is a top view SEM image of the first solid electrolyte layer according to Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In addition, it will also be understood that when a layer is referred to as being “between” two layers, it can be the only layer between the two layers, or one or more intervening layers may also be present. Like reference numerals refer to like elements throughout.

The term “combination thereof” may include a mixture, a laminate, a complex, a copolymer, an alloy, a blend, a reactant of constituents.

The terms “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

In the specification, unless explicitly described to the contrary, the word “comprise” and variations such as “comprises” or “comprising” will be understood to imply the inclusion of stated elements but not the exclusion of any other element.

In addition, the terms “about,” “substantially,” etc. used throughout the specification herein are used in the sense of being at or close to that value when manufacturing and material tolerances inherent in the stated meaning are presented and are used to prevent unscrupulous infringers from taking unfair advantage of disclosures in which precise or absolute figures are mentioned so as to aid understanding of the present disclosure.

In the specification, “A or B” is not an exclusive term, and indicates A, B, or both A and B.

Unless otherwise defined in the specification, it will be understood that when an element, such as a layer, a film, a region, a plate, and the like is referred to as being “on” or “over” another element, it may be directly on, connected to, or coupled to the other element or layer, or one or more intervening elements may be present. In addition, it will also be understood that when an element is referred to as being “between” two elements, it may be the only element between the two elements, or one or more intervening elements may also be present.

In the present invention, particle size or particle diameter may be an average particle diameter. Unless otherwise defined in the specification, the average particle diameter may be defined as an average particle diameter D50 indicating the diameter of particles having a cumulative volume of 50 volume % in the particle size distribution. The particle size may be measured by a method well known to those skilled in the art, for example, by a particle size analyzer, or by a transmission electron microscopic image, a scanning electron microscopic image), or a field emission scanning electron microscopy (FE-SEM). In another embodiments, a dynamic light-scattering measurement device is used to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of 60 W, and calculating an average particle diameter (D50) in the 50% standard of particle distribution in the measuring device. The average particle diameter may be taken the diameter (D50) of the particles with a cumulative volume of 50 volume % as the average particle diameter from a particle size distribution which is obtained by randomly measuring the size (diameter or length of long axis) of approximately 20 particles in the scanning electron microscope image.

The term “thickness” may be measured through a photograph taken with an optical microscope such as a scanning electron microscope.

An all solid-state battery according to one or more embodiments may include a negative electrode; a positive electrode; and a solid electrolyte layer between the negative electrode and the positive electrode. In an implementation, the solid electrolyte layer may include a first solid electrolyte layer in contact with the negative electrode and a second electrolyte layer in contact with the positive electrode.

In an implementation, the negative electrode may include a negative electrode current collector and a negative electrode coating layer on the negative electrode current collector. The negative electrode coating layer may be positioned in contact with the first solid electrolyte layer.

The first solid electrolyte layer may be an irregular layer, and the solid electrolyte may not have or be in a particle form. In an implementation, an irregular layer may be a single layer where the solid electrolyte particles are crushed, and thus no interface between the particles may appear or be visible. Such an irregular layer may be confirmed from a SEM in which the interface between the particles does not appear. The first solid electrolyte layer may not have the interface between the particles, so that an interface resistance may not be present, thereby reducing voids which may be generated between the particles, and thus, lithium ion conductivity may be enhanced. The lack of an interface between the particles may help effectively prevent the growth of lithium dendrites which could otherwise be generated during the battery operation.

Such a first solid electrolyte layer may be a dense layer, which may be a layer having no pores or practically almost no pores. In an implementation, the dense layer may be a layer in which pores may exist, but the pores may be present only at about 5% or less based on a total area of the layer, in a measurement of or using SEM. The first solid electrolyte layer, which may be a dense layer, may be prepared by coating a first solid electrolyte composition including an alcohol, e.g., a wet coating using an alcohol. Hereinafter, the first solid electrolyte layer preparation will be described in more detail.

In an implementation, the first solid electrolyte layer may include an alcohol, and a reduction in the ionic conductivity may be suppressed, even if the solid electrolyte is exposed to the atmosphere. In an implementation, the alcohol may include, e.g., ethanol, propanol, isopropanol, butanol, t-butylalcohol, or a combination thereof.

The first solid electrolyte layer, which may be an irregular layer and may include the alcohol, may be a dense layer which does not substantially include pores. This first solid electrolyte layer may be in contact with the negative electrode, e.g., the negative electrode coating layer and thus, the pores may be reduced at the interface between the negative electrode and the first solid electrolyte layer, thereby closely contacting the negative electrode with the first solid electrolyte layer each other and densely contact each other. This may facilitate the transfer of lithium ions released from the positive active material to the negative electrode during charge and discharge of the all solid-state battery and may render the movement uniform, thereby enhancing ionic conductivity. The lithium ions transferred to the negative electrode may pass through the negative electrode coating layer to uniformly precipitate and deposit on the negative electrode current collector. This may help inhibit the uneven precipitation and deposition of lithium ions and may help prevent lithium dendrites (which could otherwise be generated by lithium ions not passing through the negative electrode coating layer but depositing on the surface of the negative electrode coating layer).

If the solid electrolyte layer were not composed of double layers of the first solid electrolyte layer and the second solid electrolyte layer, but rather composed of only a single layer including the irregular layer structure and alcohol, the ionic conductivity of the solid electrolyte layer could be greatly decreased. If the second solid electrolyte layer were to be in contact with the positive electrode, which is the irregular layer and includes the alcohol, the solid electrolyte included in the positive electrode could be dissolved, resulting in a decrease in the ionic conductivity and an increase in resistance.

The first solid electrolyte layer according to some embodiments may include the alcohol and the first solid electrolyte, and may further include a binder.

In the first solid electrolyte layer, an amount of the alcohol may be, e.g., about 0.08 wt % to about 0.13 wt %, or about 0.1 wt % to about 0.13 wt %, based on a total weight of the first solid electrolyte layer. In the first solid electrolyte layer, including the alcohol within the above ranges may help ensure that the ionic conductivity may be more enhanced. The amount of the alcohol included in the first solid electrolyte layer may be determined by a thermogravimetric analysis (TGA).

In the first solid electrolyte layer, an amount of the first solid electrolyte may be, e.g., about 99.87 wt % to about 99.92 wt %, or about 99.87 wt % to about 99.9 wt %, based on the total weight of the first solid electrolyte layer. Maintaining the amount of the first solid electrolyte within the ranges may help ensure that the interface contact between the solid electrolyte layer and the negative electrode may be more enhanced, e.g., the adhesion characteristics may be improved.

In an implementation, the first solid electrolyte layer may further include a binder, and an amount of the binder may be, e.g., about 0.1 wt % to about 24.87 wt %, or about 0.5 wt % to about 23.87 wt %, based on the total weight of the first solid electrolyte layer. Maintaining the amount of the binder within these ranges may impart the sufficient adherence, without an increase in resistance.

In an implementation, the first solid electrolyte layer may further include a binder, and an amount of the first solid electrolyte may be, e.g., about 75 wt % to about 99 wt % or about 76 wt % to about 99 wt %, based on the total weight of the first solid electrolyte layer.

The second solid electrolyte layer may include a second solid electrolyte, and may further include a binder. In an implementation, the second solid electrolyte layer may further include the binder, and an amount of the second solid electrolyte may be, e.g., about 80 wt % to about 99.9 wt %, about 85 wt % to about 99.5 wt %, or about 99 wt % to about 90 wt %, based on a total weight of the second solid electrolyte layer. An amount of the binder may be, e.g., about 0.1 wt % to about 20 wt %, about 0.5 wt % to about 15 wt % or about 1 wt % to about 10 wt %, based on a total weight of the second solid electrolyte layer.

In the second solid electrolyte layer, including the second solid electrolyte within the foregoing ranges may help ensure that the ionic conductivity may be more improved and the interface contact between the solid electrolyte layer and the positive electrode may more enhanced, e.g., the adhesion characteristic may be more enhanced.

In an implementation, a thickness of the first solid electrolyte layer may be about 10 μm to about 200 μm, or about 20 μm to about 100 μm. Maintaining the thickness of the first solid electrolyte layer within the foregoing ranges may help ensure that the lithium dendrite growth may be suppressed.

A thickness of the second solid electrolyte layer may be about 10 μm to about 200 μm, or about 20 μm to about 100 μm. Maintaining the thickness of the second solid electrolyte layer within these ranges may help ensure that the lithium ion conductivity may be increased. In an implementation, the second solid electrolyte included in the second solid electrolyte layer may be a particle type, e.g., in a particle form.

In an implementation, the second solid electrolyte may include a large-particle solid electrolyte, e.g., large-particle solid electrolyte particles. An average particle diameter of the large-particle solid electrolyte particle may be larger than about 0.1 μm, e.g., about 0.5 μm to about 20 μm, or about 1 μm to about 10 μm. Maintaining the particle size of the second solid electrolyte within the above sizes may help ensure that the pores in the solid electrolyte may be minimized.

The first solid electrolyte may be a sulfide solid electrolyte.

The second solid electrolyte may be or include an inorganic solid electrolyte, e.g., a sulfide solid electrolyte, an oxide solid electrolyte, a halide solid electrolyte, or the like, or solid polymer electrolyte. In an implementation, the second solid electrolyte may include the sulfide solid electrolyte, and the first and the second solid electrolyte may be the same sulfide solid electrolyte, or may be different sulfide solid electrolyte each other.

The sulfide solid electrolyte may include, e.g., Li₂S—P₂S₅, Li₂S—P₂S⁵—LiX (where X is an halogen element, e.g., I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S⁵—LiI, Li₂S—B₂S₃, Li₂S—P₂S₅—ZₘSₙ (where m and n are each an integer of about 0 or more and about 12 or less, Z is Ge, Zn, or Ga), Li₂S—GeS₂, Li₂S—SiS₂—Li₃PO₄, Li₂S—SiS₂—LiₚMO_{q} ((where p and q are each an integer of about 0 or more and about 12 or less and M is P, Si, Ge, B, Al, Ga, or In), or LiₐM_{b}P_{c}S_{d}Aₑ(where a, b, c, d, and e are each an integer of about 0 or more and about 12 or less, M is Ge, Sₙ, Si, or a combination thereof, and A is F, Cl, Br, or I). The sulfide solid electrolyte may include, e.g., Li₇₋ₓPS₆₋ₓFₓ(0≤x≤2), Li₇₋ₓPS₆₋ₓClₓ(0≤x≤2), Li₂₋ₓPS₆₋ₓBrₓ(0≤x≤2) or Li₂₋ₓPS₆₋ₓIₓ(0≤x≤2). In an implementation, it may include, e.g., Li₃PS₄, Li₇P₃S₁₁, Li₇PS₆, Li₆PS₅Cl, Li₆PS₅Cl, Li₆PS₅I, Li₆PS₅Br, Li_{5.8}PS_{4.8}Cl_{1.2}, Li_{6.2}PS_{5.2}Br_{0.8}, or the like.

In an implementation, the sulfide solid electrolyte may be an argyrodite-type sulfide solid electrolyte. The argyrodite-type sulfide solid electrolyte may be, e.g., LiₐM_{b}P_{c}S_{d}Aₑ(where a, b, c, d, and e are each an integer of about 0 or more and about 12 or less, M is Ge, Sₙ, Si, or a combination thereof, and A is F, Cl, Br, or I).

In an implementation, it may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06}) PS_{4.75}Cl_{1.25}, (Li_{5.72}Cu_{0.03}) PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

The sulfide solid electrolyte may be amorphous, crystalline, or a combination thereof. The sulfide solid electrolyte may be prepared, e.g., by mixing Li₂S and P₂S⁵ at a mole ratio of about 50:50 to about 90:10, or about 50:50 to about 80:20. In these ranges of the mixing ratio, the sulfide solid electrolyte exhibiting excellent ionic conductivity may be prepared. As other components, SiS₂, GeS₂, B₂S₃, or the like may be further included thereto, thereby further improving ionic conductivity.

The mixing procedure of a sulfur-containing source for preparing the sulfide solid electrolyte may be performed by a mechanical milling or a solution method. The mechanical milling may be performed by adding starting raw material, a ball mill, or the like in a reactor and vigorously stirring to pulverize the starting raw material and to mix them together. The solution method may provide a solid electrolyte as a precipitate by mixing starting raw material in a solvent. In an implementation, the heat treatment may be performed after mixing, the crystal of the solid electrolyte may be further solidified, and ionic conductivity may be further improved. In an implementation, the sulfide solid electrolyte may be prepared by mixing sulfur-containing raw materials and heat-treating them twice or more, which may provide a sulfide solid electrolyte with high ionic conductivity and rigidity.

In an implementation, the sulfide solid electrolyte may be a commercial solid electrolyte.

The oxide inorganic solid electrolyte may be, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al, Ga)ₓ(Ti, Ge)₂₋ₓSiₓP_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics, Li₃₊ₓLa₃M₂O₁₂ (where M=Te, Nb, or Zr, x is an integer of about 1 to about 10), or a mixture thereof.

The solid polymer electrolyte may include, e.g., polyethylene oxide, poly(diallyldimethylammonium)trifluoromethanesulfonylimide (TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na, Li)₁₊ₓTi₂—Alₓ PO₄₃(0.1≤x≤0.9), Li₁₊ₓHf₂₋ₓAlₓ PO₄₃(0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (where M is a rare earth elements such as Nd, Gd, Dy, or the like), Li₅ZrP₃O₁₂, Li₃TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (0≤x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0<y≤0.6, Q is Al or Ga), Li₆BaLa₂Ta₂O₁₂, Li₇La₃Zr₂O₁₂, Li₅La₃Nb₂O₁₂, Li₅La₃M₂O₁₂ (M is Nb, Ta), or Li₇₊ₓAₓLa₃₋ₓZr₂O₁₂ (0<x<3, A is Zn).

The halide solid electrolyte may include a Li element, a M element (where M is a metal except for Li), and a X element (where X is a halogen). The X may be, e.g., F, Cl, Br, or I. In an implementation, the halide solid electrolyte may include Br or Cl, as the X. The M may be, e.g., Sc, Y, B, Al, Ga, In, or the like.

In an implementation, the halide solid electrolyte may be represented by, e.g., Li₆₋₃ₐMₐBr_{b}Cl_{c} (where, M is a metal, except for Li, 0<a<2, 0≤b≤6, 0≤c≤6, b+c=6). The a may be about 0.75 or more, or about 1 or more, and the a may be about 1.5 or less. The b may be about 1 or more, or about 2 or more. The c may be about 3 or more, or about 4 or more. In an implementation, the halide solid electrolyte may be, e.g., Li₃YBr₆, Li₃YCl₆ or Li₃YBr₂Cl₄.

A binder included in the first and the second solid electrolyte layer may be a styrene butadiene rubber, polytetrafluoroethylene, polyvinylidene fluoride, polyethylene, an acrylate polymer, or a combination thereof, or other suitable material. The acrylate polymer may include butyl acrylate, polyacrylate, polymethacrylate, or a combination thereof.

The first solid electrolyte layer and the second solid electrolyte layer may further include an alkali metal salt, an ionic liquid, or a conductive polymer.

The alkali metal salt may be, e.g., a lithium salt. In the solid electrolyte layer, a concentration of the lithium salt may be about 1 M or more, e.g., about 1 M to about 4. In this case, the lithium salt may help improve the lithium ion mobility of the first and the second solid electrolyte layers, thereby improving ionic conductivity.

The lithium salt, may be, e.g., LiSCN, LIN(CN)₂, Li(CF₃SO₂)₃C, LiC₄F₉SO₃, LiN(SO₂CF₂CF₃)₂, LiCl, LiF, LiBr, LiI, LiB C₂O₄₂, LiBF₄, LiBF₃C₂F₅, lithium bis(oxalato) borate (LiBOB), lithium oxalyldifluoroborate, LIODFB), lithium difluoro(oxalato)borate (LiDFOB), lithium bis(trifluoro methanesulfonyl)imide (LiTFSI), LiN(SO₂CF₃)₂), lithium bis(fluorosulfonyl)imide (LiFSI), LiN(SO₂F)₂), LiCF₃SO₃, LiAsF₆, LiSbF₆, LiClO₄, or a mixture thereof.

The lithium salt may be an imide lithium salt, e.g., lithium bis(trifluoro methanesulfonyl)imide (LiTFSI), LiN(SO₂CF₃)₂), lithium bis(fluorosulfonyl)imide (LiFSI), or LiN(SO₂F)₂). The lithium salt may suitably maintain the chemical reactivity with the ionic liquid, and thus, the ionic conductivity may be maintained or improved.

The ionic liquid may have a melting point of a room temperature or less which may be a liquid state at a room temperature and salts consisting of only ion, or a room-temperature molten salt.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and an anion, e.g., BF₄⁻, PF₆⁻, AsF₆⁻, SbF₆⁻, AlCl₄⁻, HSO₄⁻, ClO₄⁻, CH₃SO₃⁻; CF₃CO₂⁻, Cl⁻, Br⁻, I⁻, BF₄⁻, SO₄⁻, CF₃SO₃⁻, FSO₂₂N⁻; (C₂F₅SO₂)₂N⁻, (C₂F₅SO₂, CF₃SO₂)N⁻, or (CF₃SO₂)₂N⁻.

The ionic liquid may be, e.g., N-methyl-N-propylpyrroledinium bis(trifluoromethanesulfonyl)imide, N-butyl-N-methylpyrroleridium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

In the first and the second solid electrolyte layer, the weight ratio of the solid electrolyte and the ionic liquid may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer within the ranges may have an improved electrochemical contact area to the electrode, and thus, the ionic conductivity may be maintained or improved. This may help improve the energy density, discharge capacity, rate capability, or the like of the all solid-state battery.

The negative electrode according to some embodiments may include a negative electrode current collector and a negative electrode coating layer on the current collector.

In an implementation, the negative electrode coating layer refers to a layer that facilitates the movement of lithium ions released from the positive active material to the negative electrode during charging and discharging of the all solid-state battery, thereby facilitating their deposition on the surface of the current collector. In an implementation, a lithium-containing layer, e.g., a lithium deposition layer, due to the deposition of lithium ions between the current collector and the negative electrode coating layer may be formed, and the lithium deposition layer acts as a negative active material. This negative electrode may be a deposition-type negative electrode. The metal and amorphous carbon included in the negative electrode coating layer may not act as a negative active material that directly participates in the charge and discharge reaction. Such a deposition-type negative electrode may be a negative electrode that does not include a negative active material during the battery preparation, but the lithium-included layer acts as a negative active material.

The negative electrode coating layer may include a carbon material, a metal which serve as a catalyst, and a binder. As such, the negative electrode coating layer according to some embodiment may not include the solid electrolyte which may render to readily form a lithium deposition layer on the current collector during charging and discharging the all solid-state battery.

In the negative electrode coating layer, e.g., a metal may be supported on a carbonaceous material, or a metal and a carbonaceous material may be mixed together.

The carbonaceous material, may be, e.g., crystalline carbon, amorphous carbon, or a combination thereof. In an implementation, it may be amorphous carbon. The crystalline carbon may be, e.g., natural graphite, artificial graphite, mesophase carbon microbead, carbon nanotube, graphene, or a combination thereof. The crystalline carbon may have unspecified shape, sheet shape, flake shape, spherical shape, or fiber shape. The amorphous carbon may be, e.g., carbon black, acetylene black, denka black, ketjen black, furnace black, activated carbon, graphene, or combinations thereof. The carbon black may be Super P (available from Timcal, Ltd.).

In an implementation, the carbon material may be in the form of single, independent, or primary particles, a secondary particle in which a plurality of primary particles is agglomerated, or combinations thereof. In an implementation, the carbon material may be in the form of single particles, and the size of the carbon material may have an average particle diameter of about 100 nm or less, e.g., a nanosize of about 10 nm to about 100 nm.

In an implementation, the carbon material may be an agglomerated product, the particle diameter of the primary particle may be about 20 nm to about 100 nm, and the particle diameter of the secondary particle may be about 1 μm to about 20 μm.

In an implementation, a particle diameter of the primary particles may be about 20 nm or more, about 30 nm or more, about 40 nm or more, about 50 nm or more, about 60 nm or more, about 70 nm or more, about 80 nm or more, or about 90 nm or more, and about 100 nm or less, about 90n m or less, about 80 nm or less, about 70 nm or less, about 60 nm or less, about 50 nm or less, about 40 nm or less, or about 30 nm or less.

In an implementation, a particle diameter of the secondary particle may be about 1 μm or more, 3 μm or more, about 5 μm or more, about 7 μm or more, about 10 μm or more, or about 15 μm or more, and about 20 μm or less, about 15 μm or less, about 10 μm or less, about 7 μm or less, about 5 μm or less, or about 3 μm or less.

The shape of the primary particle may be spherical, oval, plate-shaped, or combinations thereof. In an implementation, the shape of the primary particle may be spherical, oval, or combinations thereof.

The metal may be Ag, Au, Sₙ, Zn, Al, Mg, Ge, Cu, In, Ni, Bi, Pt, Pd, or a combination thereof. The inclusion of the metal in the negative electrode coating layer may help further improve the electrical conductivity of the negative electrode.

The metal may be nano particles and the size of the metal nano particles, e.g., an average size, may be about 5 nm to about 80 nm. In an implementation, the metal nanoparticles with nano size may be used, and the battery characteristics, e.g., cycle-life characteristics of the all solid-state battery, may be improved. If the size of the metal particles were to increase to a micrometer unit, the uniformity of the metal particles could be reduced in the negative electrode coating layer, and thus, a current density could be increased at a specific region, thereby deteriorating the cycle-life characteristics.

In an implementation, an amount of the metal may be, based on the total weight of the negative electrode coating layer, about 3 wt % to about 30 wt %, about 4 wt % to about 25 wt %, about 5 wt % to about 20 wt %, or about 5 wt % to about 15 wt %.

An amount of the carbon material may be, based on the total weight of the negative electrode coating layer, about 70 wt % to about 97 wt %, about 75 wt % to about 96 wt %, about 80 wt % to about 95 wt %, or about 85 wt % to about 95 wt %.

The negative electrode coating layer may further include a binder. The binder may be a non-aqueous-based binder.

The aqueous binder may be polyvinyl chloride, carboxylated polyvinyl chloride, polyvinyl fluoride, polyethylene oxide, an ethylene propylene copolymer, polystyrene, polyvinyl pyrrolidone, polyurethane, polytetrafluoroethylene, polyvinylidene fluoride, polyethylene, polypropylene, polyamide imide, polyimides, polyacrylate, or a combination thereof.

An amount of the binder may be about 1 wt % to about 15 wt %, based on the total weight of the negative electrode coating layer. In an implementation, the binder may be included, based on the total weight of the negative electrode coating layer, at an amount of about 1 wt % or more, about 2 wt % or more, about 3 wt % or more, about 4 wt % or more, about 5 wt % or more, about 6 wt % or more, about 7 wt % or more, about 8 wt % or more, 9 wt % or more, about 10 wt % or more, about 11 wt % or more, about 12 wt % or more, about 13 wt % or more, or about 14 wt % or more, and about 15 wt % or less, about 14 wt % or less, about 13 wt % or less, about 12 wt % or less, about 11 wt % or less, about 10 wt % or less, about 9 wt % or less, about 8 wt % or less, about 7 wt % or less, about 6 wt % or less, about 5 wt % or less, about 4 wt % or less, about 3 wt % or less, or about 2 wt % or less.

Including the binder in the negative electrode coating layer of the all solid-state battery within the above weight ranges may help ensure that the electrical resistance and the adherence may be improved, thereby enhancing the battery characteristics of the all solid-state battery (battery capacity and power characteristics).

A thickness of the negative electrode coating layer may be about 1 μm to about 20 μm. In an implementation, a thickness of the negative electrode coating layer may be about 1 μm or more, about 3 μm or more, about 5 μm or more, and about 20 μm or less, about 18 μm or less, about 16 μm or less, about 14 μm or less, about 12 μm or less, or about 10 μm or less.

The current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape. A thickness of the negative electrode current collector may be about 1 μm to 20 μm, about 5 μm to about 15 μm, or about 7 μm to about 10 μm.

The current collector may include the metal as a substrate and may further include a thin film on the substrate. The thin film may include a suitable element capable of forming an alloy with lithium, e.g., gold, silver, zinc, tin, indium, silicon, aluminum, bismuth, or a combination thereof. In an implementation, the current collector may further include the thin film, and the more flattened lithium-containing layer may be formed, if the lithium is deposited during charging to form the lithium-containing layer, thereby further improving the cycle-life characteristics of the all solid-state battery.

A thickness of the thin film may be about 1 nm to about 800 nm, about 10 nm to about 700 nm, about 50 nm to about 600 nm, or about 100 nm to about 500 nm. Maintaining the thickness of the thin film within the ranges may help ensure that the cycle-life characteristics may be further enhanced.

The negative electrode according to one or more embodiments may further include a lithium-containing layer between the current collector and the negative electrode coating layer at the initial charge after the battery preparation. In an implementation, the thickness of the lithium-containing layer may be about 1 μm to about 1,000 μm, about 1 μm to about 500 μm, about 1 μm to about 200 μm, about 1 μm to about 150 μm, about 1 μm to about 100 μm, or about 1 μm to about 50 μm. Maintaining the thickness of the lithium-containing layer within these ranges may help ensure that it may effectively perform the role of a lithium reservoir and the cycle-life characteristics may be further enhanced.

The lithium-containing layer may be formed by releasing lithium ions from a positive active material, passing through the solid electrolyte, and moving move to the negative electrode, and thus, it may be precipitated and deposited on the negative electrode current collector, after fabricating the battery.

The charging may be a formation process which may be performed at 0.05 C to 1 C at about 25° C. to about 50° C. once to three times. In an implementation, lithium may be precipitated and deposited to form the lithium-containing layer, lithium included in the lithium-containing layer may be ionized during discharging to move to the positive direction, and thus, this lithium may be used as a negative active material.

In an implementation, the lithium-containing layer may be positioned between the current collector and the negative electrode coating layer, the negative electrode coating layer may serve as a protecting layer for the lithium-containing layer, and thus, the deposition growth of lithium dendrite may be suppressed. This may help inhibit capacity fading and short-circuit of the all solid-state battery and resultantly improve the cycle-life of the all solid-state battery.

The positive electrode may include a positive current collector and a positive active material layer on the positive current collector.

The positive active material layer may include a positive active material. The positive active material may include compounds that reversibly intercalate and deintercalate lithium ions. In an implementation, it may include a composite oxide of a metal, e.g., cobalt, manganese, nickel, or a combination thereof, and lithium. In an implementation, the positive active material may include, e.g., LiₐA_{1-b}B¹₆D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤c≤1.8, 0≤b≤0.5, 0≤c≤0.5); LiₐNi_{1-b-c}Co_{b}B¹_{c}D¹_{α} (0.90≤a≤1.8, 0≤b≤0.5, 0≤c≤0.5, 0≤α≤2); LiₐNi_{1-b-c}Co_{b}B¹_{c}O_{2-α}F¹_{α} (0.90≤a≤1.8, 0≤b≤0.5, 0≤c≤0.5, 0<α≤2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0<α<0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂(PO₄)₃ (0≤f≤2); Li_{(3-f)}Fe₂(PO₄)₃ (0≤f≤2); or LiFePO₄.

In the chemical formulas A may be Ni, Co, Mn, or a combination thereof; B¹ may be Al, Ni, Co, Mn, Cr, Fe, Mg, Sr, V, a rare earth element, or a combination thereof; D¹ may be O, F, S, P, or combination thereof; E may be Co, Mn, or combination thereof; F¹ may be F, S, P, or a combination thereof; G may be Al, Cr, Mn, Fe, Mg, La, Ce, Sr, V, or a combination thereof; Q may be Ti, Mo, Mn, or a combination thereof; I¹ may be Cr, V, Fe, Sc, Y, or a combination thereof; J may be V, Cr, Mn, Co, Ni, Cu, or a combination thereof; L¹ may be Mn, Al, or a combination thereof.

In an implementation, the positive active material may be a three-component (e.g., three transition metal) lithium transition metal oxide such as LiNiₓCo_{y}Al₂O₂ (NCA), LiNiₓCo_{y}Mn_{z}O₂ (NCM) (wherein, 0<x<1, 0<y<1, 0<z<1, x+y+z=1), etc.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or mixture thereof. The coating layer may be provided by a method having no (or substantially no) adverse influence on properties of a positive active material by using these elements in the compound. In an implementation, the method may include a suitable coating method such as spray coating, dipping, or the like.

In an implementation, the coating layer may include suitable coating materials for the positive active material of the all solid battery, e.g., Li₂O—ZrO₂ (LZO) or the like.

In an implementation, the positive active material may include three-components including nickel, cobalt, and manganese, or nickel, cobalt, and aluminum, the capacity density of the all solid-state battery may be further improved, and the metal elution from the positive active material at charged state may be further reduced. This may help further improve long reliability and cycle characteristics of the all solid-state battery at charged state.

The shape of the positive active material may be, e.g., particle shapes such as a spherical shape and a spherical shape. The average particle diameter of the positive active material may be in a suitable range which may be applied to a positive active material of an all solid secondary battery. The amount of the positive active material included in the positive active material may be in a suitable range which may be applied to a positive active material of the all solid secondary battery.

The positive active material layer may further include a solid electrolyte. The solid electrolyte included in the positive active material layer may be the same to or different from the solid electrolyte included in the first and the second solid electrolyte layer. The solid electrolyte may be included in an amount of about 10 wt % to about 30 wt %, based on the total weight of the positive active material layer.

The positive current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

The positive active material layer may further include a binder or a conductive material.

The binder may include polyvinyl alcohol, carboxymethyl cellulose, hydroxypropyl cellulose, diacetyl cellulose, polyvinylchloride, carboxylated polyvinylchloride, polyvinyl fluoride, polyethylene oxide, polyvinylpyrrolidone, polyurethane, polytetrafluoroethylene, polyvinylidene fluoride, polyvinylidene fluoride-hexafluoropropylene, polyethylene, polypropylene, styrene-butadiene rubber, an acrylated styrene-butadiene rubber, epoxy resin, nylon, or the like.

The binder may be included in an amount of about 0.1 wt % to about 5 wt %, or about 0.1 wt % to about 3 wt %, based on the total weight of the positive active material layer for the all solid-state battery. In these ranges of amount, the binder may sufficiently demonstrate its adhesion ability without deteriorating the battery performances.

The conductive material may be included to provide electrode conductivity. A suitable electrically conductive material that does not cause a chemical change may be used as a conductive material. Examples of the conductive material may include a carbon material such as natural graphite, artificial graphite, carbon black, acetylene black, ketjen black, carbon fiber, carbon nanofiber, carbon nanotube and the like; a metal material of a metal powder or a metal fiber including; copper, nickel, aluminum, silver, and the like; a conductive polymer such as polyphenylene derivatives; or mixtures thereof.

The conductive material may be included in an amount of about 0.1 wt % to about 5 wt %, or about 0.1 wt % to about 3 wt %, based on the total weight of the positive active material layer for the all solid-state battery. Including the conductive material in the above amount ranges may help improve the electrical conductivity without deteriorating battery performance.

A thickness of the positive active material layer may be about 90 μm to about 200 μm. In an implementation, a thickness of the positive active material layer may be about 90 μm or more, about 100 μm or more, about 110 μm or more, about 120 μm or more, about 130 μm or more, about 140 μm or more, about 150 μm or more, about 160 μm or more, about 170 μm or more, about 180 μm or more, or about 190 μm or more, and about 200 μm or less, about 190 μm or less, about 180 μm or less, about 170 μm or less, about 160 μm or less, 150 μm or less, about 140 μm or less, about 130 μm or less, about 120 μm or less, or about 110 μm or less.

In an implementation, a buffer material may be additionally included to buffer thickness changes that occur when the all-solid-state battery is charged and discharged. The buffer material may be present between the negative electrode and the case, and in the case of a battery in which one or more electrode assemblies are stacked, it may be present between different electrode assemblies.

The buffer material may include a material that has an elastic recovery rate of 50% or more and has an insulating function, e.g., it may include silicone rubber, acrylic rubber, fluorine rubber, nylon, synthetic rubber, or a combination thereof. The buffer material may be present in the form of a polymer sheet.

### <Method of Preparing all Solid-State Battery>

An all solid-state battery according to some embodiments may be prepared by coating a first solid electrolyte layer composition (having a viscosity of about 5 cPs to about 1,000 cPs at 25° C.) on a negative electrode and drying to prepare a first solid electrolyte layer; positioning a second solid electrolyte layer and a positive electrode on the first solid electrolyte layer to prepare a laminate; and pressurizing the laminate. Hereinafter, each procedure will be illustrated in more detail.

First of all, a first solid electrolyte layer composition with a viscosity of about 5 cPs to about 1,000 cPs may be coated on a negative electrode and dried to prepare a first solid electrolyte layer. The negative electrode may include a negative electrode current collector and a negative electrode coating layer on the negative electrode current collector. In an implementation, the procedure may be carried out by coating the first solid electrolyte layer composition on a negative electrode coating layer.

A viscosity of the first solid electrolyte layer composition may be about 5 cPs to about 1,000 cPs at about 20° C. to about 25° C., e.g., about 10 cPs to about 900 cPs, or about 100 cPs to about 800 cPs. Maintaining the viscosity of the first solid electrolyte layer composition at about 5 cPs or greater may help ensure that the first solid electrolyte layer composition may not be totally impregnated on the negative electrode, e.g., the negative electrode coating layer. Maintaining the viscosity of the first solid electrolyte layer composition at about 1,000 cPs or less may help ensure that the coating may be carried out.

The first solid electrolyte layer composition may include a first solid electrolyte and an alcohol. The first solid electrolyte layer composition may further include a binder. The first solid electrolyte, the alcohol, and the binder may be as described above.

In the first solid electrolyte layer composition, the amounts of the first solid electrolyte and the alcohol, and optionally, the binder may be appropriately adjusted in order to satisfy the viscosity of the first solid electrolyte layer composition. In an implementation, an amount of the first solid electrolyte may be, based on a total weight of the first solid electrolyte layer composition, about 1 wt % to about 20 wt %, about 2 wt % to about 15 wt %, or about 5 wt % to about 10 wt %. A total amount of the alcohol and the binder may be about 80 wt % to about 99 wt %, about 85 wt % to about 98 wt %, or about 90 wt % to about 95 wt %. Within these ranges, a mixing ratio of the alcohol and the binder may be a weight ratio of about 0.1:99.9 to about 4:96, or a weight ratio of about 0.1:99.9 to about 3.5:96.5.

The drying may be carried out at about 50° C. to about 250° C., or about 80° C. to about 200° C. According to the drying, alcohol may be volatilized from the first solid electrolyte layer composition to thus be at least partially removed. Performing the drying at these temperature ranges may help ensure that the alcohol may remain in the first solid electrolyte layer, e.g., at an amount of about 0.08 wt % to about 0.13 wt % or about 0.08 wt % to about 0.13 wt %, based on the total weight of the first solid electrolyte layer.

Thereafter, a second solid electrolyte layer and a positive electrode may be sequentially positioned on the first solid electrolyte layer to prepare a laminate.

The second solid electrolyte layer may be prepared by adding the second solid electrolyte to a binder solution, coating it onto a substrate film, and drying. A solvent of the binder solution may be isobutyl isobutyrate, xylene, toluene, benzene, hexane, or a combination thereof. The binder in the binder solution may be as described above.

Thereafter, the laminate may be pressurized or pressed. The pressurization may be carried out at a temperature of about 25° C. to about 90° C. The pressurization may be carried out under a pressure of about 550 MPa, e.g., about 500 MPa or less, or a pressure of about 1 MPa to about 500 MPa. The pressurization time may vary depending on temperature and pressure, e.g., it may be less than about 30 minutes. The pressurization may be, e.g., isostatic press, roll press, plate press, or warm isostatic press (WIP.

The all solid-state battery may be an unit battery including a structure of the positive electrode/the solid electrolyte layer/the negative electrode, a bicell including a structure of the positive electrode/the solid electrolyte layer/the negative electrode/the solid electrolyte layer/the positive electrode, or a stacked battery where the unit batteries are repeated.

The shapes of the all solid-state battery may include, e.g., a coin-type, a button-type, a sheet-type, a laminate-type, a cylindrical-type, or a flat-type, or the like. The all solid-state battery may be applied to medium-to-large batteries used in electric vehicles. In an implementation, the all solid-state battery may be also used in hybrid vehicles such a plug-in hybrid electric vehicle (PHEV), or the like. It may be applied to areas where a large amount of power storage is required, for example, it may also be applied to electric bicycles or power tools. Furthermore, the all solid-state rechargeable battery may be used in various fields such as portable electronic devices.

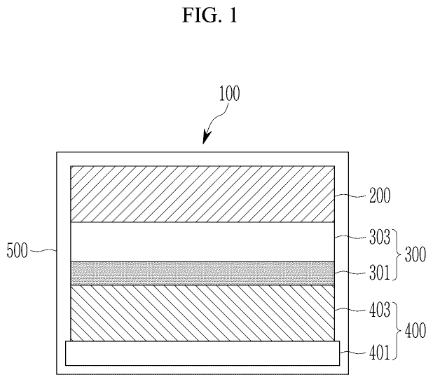

FIG. 1 is a cross-sectional view showing the all solid-state battery according to embodiments. Referring to FIG. 1, the all solid-state battery 100 may have a structure in which an electrode assembly is stacked with a negative electrode 400 including a negative electrode current collector 401 and a negative electrode coating layer 403, a solid electrolyte layer 300 including a first solid electrolyte layer 301 and a second solid electrolyte layer 303, and a positive electrode 200 including a positive active material layer 203 and a positive current collector 201, are housed in a case such as a pouch, or the like. The all solid-state battery may further include a battery case 500 in which the internal elements are housed. As illustrated in FIG. 1, one electrode assembly may include a negative electrode 400, a solid electrolyte layer 300, and a positive electrode 200, or it may be an all solid-state battery fabricated by stacking at least two electrode assembly. In an implementation, two to 100 electrode assemblies, three to 50 electrode assemblies, or 4 to 20 assemblies, or the like may be stacked.

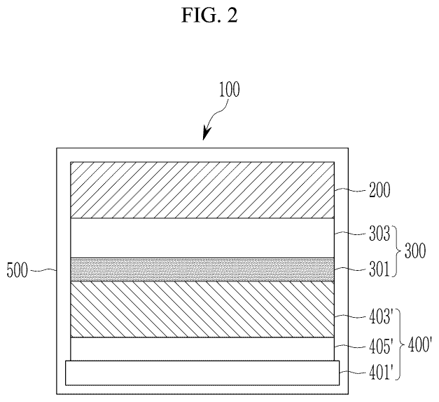

FIG. 2 is a schematic cross-sectional view of the all solid-state battery of one or more embodiments. The all solid-state battery 100 shown in FIG. 2 may include a positive electrode 200 including a positive current collector 201 and a positive active material layer 203, a negative electrode 400′ including a negative electrode current collector 401′ and a negative electrode coating layer 403′, a first solid electrolyte layer 301 and a second solid electrolyte layer 303 in a solid electrolyte layer 300 between the positive electrode 200 and the negative electrode 400′, and a battery case 500 in which these are housed. A lithium deposition layer 405′ may be between the negative electrode current collector 401′ and the negative electrode coating layer 403′. Such a lithium deposition layer may be formed by releasing lithium ions from the positive electrode to deposit on the negative electrode current collector 401′ during charging.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1) Preparation of a Negative Electrode

92 wt % of carbon black with an average particle diameter (D50) of 30 nm, 3 wt % of Ag with an average particle diameter (D50) of 60 nm, 2 wt % of carboxymethyl cellulose, and 3 wt % of a styrene-butadiene rubber were mixed in a water to prepare a negative electrode coating layer slurry.

The negative electrode coating layer slurry was coated on a stainless steel foil current collector with a thickness of 10 μm and vacuum-dried at 80° C. to prepare a negative electrode. In the prepared negative electrode, a thickness of the negative electrode coating layer was 2 μm.

### (2) Preparation of a Solid Electrolyte Layer

An argyrodite-type solid electrolyte Li₆PS₅Cl, butyl acrylate, and ethanol were mixed. A mixing ratio of the solid electrolyte, the binder, and the ethanol was a weight ratio of 10:0.1:89.9.

The mixing process was carried out using a Thinky mixer. 2 mm zirconia balls were added to the mixture, which was repeatedly agitated using a Thinky mixer to prepare a first solid electrolyte layer composition with a viscosity of 500 cPs at 25° C.

The first solid electrolyte layer composition was coated on the negative electrode coating layer and dried at 200° C. to prepare a first solid electrolyte layer with a thickness of 30 μm.

To an argyrodite-type solid electrolyte Li₆PS₅Cl with an average particle diameter (D50) of 3 μm, a binder solution in which butyl acrylate as an acrylate polymer was added to an isobutyl isobutyrate binder solution (solid amount: 50 wt %) was added and then mixed. A mixing ratio of the solid electrolyte and the binder was a weight ratio of 98.7:1.3.

The mixing process was carried out using a Thinky mixer. 2 mm zirconia balls were added to the mixture, which was repeatedly agitated using a Thinky mixer to prepare a slurry. The slurry was casted on a release polytetrafluoroethylene film and dried at ambient temperature to prepare a second solid electrolyte layer with a thickness of 100 μm.

### (3) Preparation of Positive Electrode

A positive active material (LiNi_{0.9}Mn_{0.05}Co_{0.05}O₂), an argyrodite-type solid electrolyte Li₆PS₅Cl, a conductive material carbon nano fiber, and a binder polytetrafluoroethylene were mixed at a weight ratio of 85:15:3:1.5 to prepare a mixture.

The mixture was coated on an aluminum foil current collector and then vacuum-dried at 45° C. to prepare a positive electrode including a positive active material layer with a thickness of 160 μm and a current collector with a thickness of 10 μm.

### (4) Fabrication of all Solid-State Full Cell

The prepared negative electrode, the solid electrolyte layer, and the positive electrode were sequentially stacked, and a pressure of 16 MPa was applied to fabricate an all solid-state full cell. The second solid electrolyte layer was positioned to contact with the positive electrode.

### Example 2

An all solid-state full cell was fabricated by the same procedure as in Example 1, except that a mixing ratio of the solid electrolyte, the binder, and the ethanol was a weight ratio of 10:1:89 to prepare a first solid electrolyte layer composition with a viscosity of 700 cPs at 25° C.

### Example 3

An all solid-state full cell was fabricated by the same procedure as in Example 1, except that a mixing ratio of the solid electrolyte, the binder, and the ethanol was a weight ratio of 10:3:87 to prepare a first solid electrolyte layer composition with a viscosity of 800 cPs at 25° C.

### Example 4

An all solid-state full cell with the first solid electrolyte layer with a thickness of 30 μm was fabricated by the same procedure as in Example 1, except that isopropanol was used instead of methanol to prepare a first solid electrolyte layer composition with a viscosity of 500 cPs at 25° C.

### Example 5

An all solid-state full cell with the first solid electrolyte layer with a thickness of 30 μm was fabricated by the same procedure as in Example 1, except that the solid electrolyte, the binder, and the isopropanol was mixed at a weight ratio of 10:1:89 to prepare a first solid electrolyte layer composition with a viscosity of 700 cPs at a room temperature (25° C.).

### Comparative Example 1

To an argyrodite-type solid electrolyte Li₆PS₅Cl, an isobutyl isobutyrate binder solution (solid amount: 50 wt %) to which butyl acrylate as an acrylate polymer was added, was added and then mixed. A mixing ratio of the solid electrolyte and the binder was set to be a weight ratio of 98.7:1.3.

The mixing process was carried out using a Thinky mixer. 2 mm zirconia balls were added to the mixture, which was repeatedly agitated using a Thinky mixer to prepare a slurry. The slurry was casted on a release polytetrafluoroethylene film and dried at ambient temperature to prepare a solid electrolyte layer with a thickness of 100 μm.

The solid electrolyte layer, and the negative electrode and the positive electrode of Example 1 were used to fabricate an all solid-state full cell by the same procedure in Example 1.

### Comparative Example 2

### (1) Preparation of Negative Electrode

92 wt % of carbon black and silver with an average particle diameter D50 of 30 nm, 3 wt % of Ag with an average particle diameter D50 of 60 nm, 2 wt % of carboxymethyl cellulose, and 3 wt % of a styrene butadiene rubber were mixed in water to prepare a negative electrode coating layer slurry.

The negative electrode coating layer slurry was coated on a stainless steel foil current collector with a thickness of 10 μm and vacuum-dried at 80° C. to prepare a negative electrode. In the prepared negative electrode, a thickness of the negative electrode coating layer was 2 μm.

An argyrodite-type solid electrolyte Li₆PS₅Cl, butyl acrylate, and methanol were mixed. A mixing ratio of the solid electrolyte, the binder, and the ethanol was a weight ratio of 10:1:89.

The mixing process was carried out using a Thinky mixer. 2 mm zirconia balls were added to the mixture, which was repeatedly agitated using a Thinky mixer to prepare a solid polymer slurry with a viscosity of 500 cPs at 25° C.

The solid polymer layer slurry was coated on the negative electrode coating layer and dried at 200° C. to prepare a negative electrode in which the solid electrolyte was impregnated.

### (2) Preparation of Solid Electrolyte Layer

To an argyrodite-type solid electrolyte Li₆PS₅Cl, an isobutyl isobutyrate binder solution (solid amount: 50 wt %) to which butyl acrylate as an acrylate polymer was added, was added and then mixed. A mixing ratio of the solid electrolyte and the binder was set to be a weight ratio of 98.7:1.3.

The mixing process was carried out using a Thinky mixer. 2 mm zirconia balls were added to the mixture, which was repeatedly agitated using a Thinky mixer to prepare a slurry. The slurry was casted on a release polytetrafluoroethylene film and dried at ambient temperature to prepare a solid electrolyte layer with a thickness of 100 μm.

The prepared negative electrode, the solid electrolyte layer, and the positive electrode of Example 1 were sequentially stacked, and a pressure of 16 MPa was applied to fabricate an all solid-state full cell.

### Comparative Example 3

### (1) Preparation of Negative Electrode

92 wt % of carbon black and silver with an average particle diameter D50 of 30 nm, 3 wt % of Ag with an average particle diameter D50 of 60 nm, 2 wt % of carboxymethyl cellulose, and 3 wt % of a styrene butadiene rubber were mixed in water to prepare a negative electrode coating layer slurry.

The negative electrode coating layer slurry was coated on a stainless steel foil current collector with a thickness of 10 μm and vacuum-dried at 80° C. to prepare a negative electrode. In the prepared negative electrode, a thickness of the negative electrode coating layer was 2 μm.

### (2) Preparation of Solid Electrolyte Layer

An argyrodite-type solid electrolyte Li₆PS₅Cl, butyl acrylate, and methanol were mixed. A mixing ratio of the solid electrolyte, the binder, and the methanol was a weight ratio of 10:1:89.

The mixing process was carried out using a Thinky mixer. 2 mm zirconia balls were added to the mixture, which was repeatedly agitated using a Thinky mixer to prepare a solid polymer layer slurry with a viscosity of 500 cPs at 25° C.

The solid polymer layer slurry was coated on the negative electrode coating layer and dried at 200° C. to prepare a solid electrolyte layer with a thickness of 20 μm.

The prepared negative electrode and the solid electrolyte layer, and the positive electrode of Example 1 were sequentially stacked, and a pressure of 16 MPa was applied to fabricate an all solid-state full cell.

### Comparative Example 4

### (1) Preparation of Positive Electrode

A positive active material (LiNi_{0.9}Mn_{0.05}Co_{0.05}O₂), an argyrodite-type solid electrolyte Li₆PS₅Cl, a conductive material carbon nano fiber, and a binder polytetrafluoroethylene were mixed at a weight ratio of 85:15:3:1.5 to prepare a mixture.

The mixture was coated on an aluminum foil current collector and then vacuum-dried at 45° C. to prepare a positive electrode including a positive active material layer with a thickness of 160 μm and a current collector with a thickness of 10 μm.

### (2) Preparation of a Solid Electrolyte Layer

An argyrodite-type solid electrolyte Li₆PS₅Cl, butyl acrylate, and methanol were mixed. A mixing ratio of the solid electrolyte, the binder, and the methanol was a weight ratio of 10:1:89.

The mixing process was carried out using a Thinky mixer. 2 mm zirconia balls were added to the mixture, which was repeatedly agitated using a Thinky mixer to prepare a first solid polymer layer slurry.

The first solid polymer layer slurry was coated on the negative electrode coating layer and dried at 200° C. to prepare a solid electrolyte layer with a thickness of 20 μm.

To an argyrodite-type solid electrolyte Li₆PS₅Cl, an isobutyl isobutyrate binder solution (solid amount: 50 wt %) to which butyl acrylate as an acrylate polymer was added, was added and then mixed. A mixing ratio of the solid electrolyte and the binder was set to be a weight ratio of 98.7:1.3.

The mixing process was carried out using a Thinky mixer. 2 mm zirconia balls were added to the mixture, which was repeatedly agitated using a Thinky mixer to prepare a slurry. The slurry was casted on a release polytetrafluoroethylene film and dried at ambient temperature to prepare a second solid electrolyte layer with a thickness of 100 μm.

### (3) Preparation of Negative Electrode

92 wt % of carbon black and silver with an average particle diameter D50 of 30 nm, 3 wt % of Ag with an average particle diameter D50 of 60 nm, 2 wt % of carboxymethyl cellulose, and 3 wt % of a styrene butadiene rubber were mixed in water to prepare a negative electrode coating layer slurry.

The negative electrode coating layer slurry was coated on a stainless steel foil current collector with a thickness of 10 μm and vacuum-dried at 80° C. to prepare a negative electrode. In the prepared negative electrode, a thickness of the negative electrode coating layer was 2 μm.

### (4) Fabrication of all Solid-State Full Cell

The prepared positive electrode, the solid electrolyte layer, and the negative electrode were sequentially stacked, and a pressure of 16 MPa was applied to fabricate an all solid-state full cell. The second solid electrolyte layer was positioned to contact with the negative electrode.

### Comparative Example 5

An all solid-state full cell with the first solid electrolyte layer with a thickness of 30 μm was fabricated by the same procedure as in Example 1, except that dimethyl amine was used instead of methanol to prepare a first solid electrolyte layer composition with a viscosity of 500 cPs at 25° C.

### Experimental Example 1) Measurement of SEM

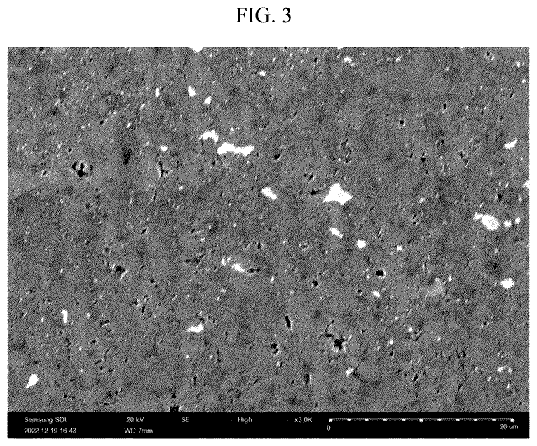

Top view SEM images of the first solid electrolyte layers according to the Example 1 to 5 as observed from top were captured. Among these results, the result of Example 1 is shown in FIG. 3. As shown in FIG. 3, no regular shape or clear interface was observed in the cross-section in the first solid electrolyte, e.g., no interface between particles showed, and thus, the result indicates that he first solid electrolyte layer was an irregular layer. In FIG. 3, pores (black in FIG. 3) are rarely visible, and the area where pores were present is 5% or less based on the total area, indicating that the first solid electrolyte layer prepared by Example 1 is a dense layer.

### Experimental Example 2) Measurement of Alcohol Amount

Amounts of ethanol, isopropanol, and methanol included in the all solid-state cell of Examples 1 to 5, and Comparative Examples 2 and 5 were determined by GC (gas chromatography)/FID (flame ionization detection) techniques. The results are shown in Table 1. In Table 1, the amount of Comparative Example 5 was an amount of dimethylamine.

TABLE 1

| | Amount of alcohol (wt %) |
|---|---|
| Example 1 | 0.1023 |
| Example 2 | 0.1127 |
| Example 3 | 0.1051 |
| Example 4 | 0.1103 |
| Example 5 | 0.1078 |
| Comparative Example 2 | 0.0773 |
| Comparative Example 5 | 0.1372(amount of dimethylamine) |

As shown in Table 1, in Examples 1 to 5, the amounts of alcohol were found to be 0.1023 wt % to 0.1127 wt %. IN Comparative Example 2, the amount of alcohol was 0.0773 wt % which was out of the range of 0.08 wt % to 0.13 wt %.

### Experimental Example 3) Evaluation of Ionic Conductivity

The ionic conductivity of the all solid-state cells of Examples 1 to 5 and Comparative Examples 1 to 5 were measured. The results are shown in Table 2. The ionic conductivity was determined by using electric impedance spectroscopy measurement device of VSP model available from Bio-Logic SAS VSP mol. Herein, frequencies from 10,000 M Hz to 1 Hz were scanned by using an amplitude of 1,000 mV at an open circuit potential.

TABLE 2

| | Ionic conductivity (S/cm) |
|---|---|
| Example 1 | 0.68 |
| Example 2 | 0.51 |
| Example 3 | 0.59 |
| Example 4 | 0.45 |
| Example 5 | 0.44 |
| Comparative Example 1 | 0.41 |
| Comparative Example 2 | 0.35 |
| Comparative Example 3 | 0.38 |
| Comparative Example 4 | 0.32 |
| Comparative Example 5 | 0.21 |

As shown in Table 2, the half-cells of Examples 1 to 5 (in which the solid polymer layers included double layer of the first and the second polymer layers and the first polymer layer including alcohol at an amount of 0.1023 wt % to 0.1127 wt % was positioned to be contact with the negative electrode) exhibited superior ionic conductivity, compared to Comparative Example 1, which did not include the first solid electrolyte layer.

Comparative Example 2, which did not include a first solid electrolyte layer of an embodiment and in which solid electrolyte was distributed throughout the negative electrode coating layer, exhibited a worse ionic conductivity than Comparative Example 1.

In a case of only including the first solid electrolyte layer of an embodiment (e.g., Comparative Example 3), or in case of positioning the first solid electrolyte layer of an embodiment in contact with the positive electrode (e.g., Comparative Example 4), they exhibited worse ionic conductivity than Comparative Example 1.

Comparative Example 5, in which the first solid electrolyte layer was prepared by a wet process, e.g., using an organic solvent other than alcohol, exhibited a worse ionic conductivity than Comparative Example 1.

One or more embodiments may provide an all solid-state battery exhibiting excellent battery performance and safety.

An all solid-state battery according to some embodiments may help improve the interface contact between the negative electrode and the solid electrolyte layer, thereby exhibiting excellent battery characteristics.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all solid-state battery, comprising:
a negative electrode;
a positive electrode; and
a solid electrolyte layer between the negative electrode and the positive electrode,
wherein:
the solid electrolyte layer includes:
a first solid electrolyte layer in contact with the negative electrode, and
a second solid electrolyte layer in contact with the positive electrode,
the first solid electrolyte layer is an irregular layer and includes an alcohol.

2. The all solid-state battery as claimed in claim 1, wherein the first solid electrolyte layer is a dense layer.

3. The all solid-state battery as claimed in claim 1, wherein the first solid electrolyte layer includes the alcohol in an amount of about 0.08 wt % to about 0.13 wt %, based on a total weight of the first solid electrolyte layer.

4. The all solid-state battery as claimed in claim 1, wherein:
the first solid electrolyte layer includes a first solid electrolyte, and
the first solid electrolyte includes a sulfide solid electrolyte.

5. The all solid-state battery as claimed in claim 1, wherein:
the second solid electrolyte layer includes a second solid electrolyte, and
the second solid electrolyte includes a sulfide solid electrolyte, an oxide solid electrolyte, a halide solid electrolyte, or a solid polymer electrolyte.

6. The all solid-state battery as claimed in claim 1, wherein:
the negative electrode includes a negative electrode current collector and a negative electrode coating layer on the negative electrode current collector, and
the negative electrode coating layer includes a metal, a carbon material, and a binder.

7. The all solid-state battery as claimed in claim 6, wherein the carbon material includes amorphous carbon, crystalline carbon, or a mixture thereof.

8. The all solid-state battery as claimed in claim 6, wherein the metal includes Ag, Au, Sn, Zn, Al, Mg, Ge, Cu, In, Ni, Bi, Pt, Pd, or a combination thereof.

9. The all solid-state battery as claimed in claim 1, wherein the alcohol includes ethanol, propanol, isopropanol, butanol, t-butanol, or a combination thereof.

10. The all solid-state battery as claimed in claim 1, wherein the first solid electrolyte layer has a thickness of about 10 μm to about 200 μm.

11. The all solid-state battery as claimed in claim 1, wherein the second solid electrolyte layer has a thickness of about 10 μm to about 200 μm.

12. The all solid-state battery as claimed in claim 1, wherein the second solid electrolyte layer includes a large-particle solid electrolyte having a particle diameter of more than about 0.1 μm.

13. The all solid-state battery as claimed in claim 12, wherein the large-particle solid electrolyte has a particle diameter of about 0.5 μm to about 20 μm.

14. A method of preparing an all solid-state battery, the method comprising:
coating a first solid electrolyte layer composition having a viscosity of about 5 cPs to about 1,000 cPs at 25° C. on a negative electrode and drying to prepare a first solid electrolyte layer;
positioning a second solid electrolyte layer and a positive electrode on the first solid electrolyte layer to prepare a laminate, and
pressurizing the laminate.

15. The method of preparing the all solid-state battery as claimed in claim 14, wherein the first solid electrolyte layer composition includes a first solid electrolyte and an alcohol.

16. The method of preparing the all solid-state battery as claimed in claim 15, wherein the alcohol includes ethanol, propanol, isopropanol, butanol, t-butanol, or a combination thereof.

17. The method of preparing the all solid-state battery as claimed in claim 14, wherein the first solid electrolyte layer composition includes a first solid electrolyte in an amount of about 1 wt % to about 20 wt %, based a total weight of the first solid electrolyte layer composition.
